(19) United States
(12) Patent Application Publication
(10) Pub. No.: US 2023/0031745 A1
(43) Pub. Date: Feb. 2, 2023

(54) MEMORY SYSTEM AND CONTROLLER OF MEMORY SYSTEM

(71) Applicant: SK hynix Inc., Gyeonggi-do (KR)

(72) Inventor: Jung Ki NOH, Gyeonggi-do (KR)

(21) Appl. No.: 17/560,699

(22) Filed: Dec. 23, 2021

(30) Foreign Application Priority Data
Aug. 2, 2021 (KR) 10-2021-0101567

(51) Int. Cl. G06F 3/06

(52) U.S. Cl. CPC G06F 3/0659; G06F 3/0616; G06F 3/064; G06F 3/0653; G06F 3/0673

(57) ABSTRACT

A memory system includes a plurality of memory devices and a controller. Each of the plurality of memory devices includes a plurality of zone blocks. One or more memory devices of the plurality of memory devices are coupled to each of a plurality of channels. The controller is configured to determine, when there are two or more channels in a predetermined status from among the plurality of channels, a target channel from among the plurality of channels in the predetermined status based on accumulated amounts of read data respectively corresponding to the plurality of channels in the predetermined status, and determine a new open zone block within a memory device coupled to the target channel.

### CROSS-REFERENCES TO RELATED APPLICATION

The present application claims priority under 35 U.S.C. § 119(a) to Korean Patent application number 10-2021-0101567, filed on Aug. 2, 2021, which is incorporated herein by reference in its entirety as set forth in full.

### BACKGROUND

### 1. Technical Field

Various embodiments of the present disclosure are related to a memory system, and more particularly, to a memory system including a nonvolatile memory device.

### 2. Related Art

A memory system may be configured to store data provided from a host device in response to a write request from the host device. Furthermore, the memory system may be configured to provide stored data to the host device in response to a read request from the host device. The host device is an electronic device capable of processing data and may include a computer, a digital camera, a mobile phone and so forth. To operate, the memory system may be built in the host device or may be fabricated to be connected to and removed from the host device.

### SUMMARY

In an embodiment of the present disclosure, a memory system may include a plurality of memory devices and a controller. Each of the plurality of memory devices may include a plurality of zone blocks. One or more memory devices of the plurality of memory devices may be coupled to each of a plurality of channels. The controller may be configured to determine, when there are two or more channels in a predetermined status from among the plurality of channels, a target channel from among the plurality of channels in the predetermined status based on accumulated amounts of read data respectively corresponding to the plurality of channels in the predetermined status, and determine a new open zone block within a memory device coupled to the target channel.

In an embodiment of the present disclosure, a memory system may include a plurality of memory devices and a controller. Each of the plurality of memory devices may include a plurality of zone blocks. One or more memory devices of the plurality of memory devices may be coupled to each of a plurality of channels. The controller may be configured to determine, when all of the plurality of channels are in an in-use status, a target channel from among the plurality of channels based on estimated remaining capacities respectively corresponding to the plurality of channels, and determine a new open zone block within a memory device coupled to the target channel.

In an embodiment of the present disclosure, a controller of a memory system may include a channel status determining unit, a target channel determining unit and an open zone block determining unit. The channel status determining unit may be configured to determine statuses respectively corresponding to channels, each of which is coupled to one or more memory devices of a plurality of memory devices. The target channel determining unit may be configured to determine, according to the determination of the channel status determining unit, a target channel from among the channels based on channel information, which includes accumulated amounts of read data respectively corresponding to the channels and/or estimated remaining capacities respectively corresponding to the channels. The open zone block determining unit may be configured to determine a new open zone block within a memory device coupled to the target channel.

In an embodiment of the present disclosure, an operating method of a controller may include checking whether each of memory devices is a candidate having only a free zone block without any open zone block; and opening a free zone block within: a target having a least accumulated amount of read data among two or more candidates when the two or more candidates are checked, a candidate when only the candidate is checked, and a memory device having a greatest available storage capacity among the memory devices when any candidate is not checked.

### BRIEF DESCRIPTION OF THE DRAWINGS

FIG. 1 is a block diagram illustrating a data processing system including a memory system according to an embodiment of the present disclosure.

FIG. 2 is a diagram illustrating an operation of mapping zones with zone blocks according to an embodiment of the present disclosure.

FIG. 3 is a detailed block diagram illustrating a controller according to an embodiment of the present disclosure.

FIGS. 4 to 7 are diagrams illustrating an operation that the controller determines a target channel from among channels according to an embodiment of the present disclosure.

FIG. 8 is a flowchart illustrating an operation of the memory system of FIG. 1 according to an embodiment of the present disclosure.

FIGS. 9A and 9B are diagrams illustrating an effect when open zone blocks are evenly arranged for channels according to an embodiment of the present disclosure.

FIG. 10 is a diagram illustrating a data processing system including a solid state drive (SSD) in accordance with an embodiment of the present disclosure.

FIG. 11 is a diagram illustrating a data processing system including a memory system in accordance with an embodiment of the present disclosure.

FIG. 12 is a diagram illustrating a data processing system including a memory system in accordance with an embodiment of the present disclosure.

FIG. 13 is a diagram illustrating a network system including a memory system in accordance with an embodiment of the present disclosure.

FIG. 14 is a block diagram illustrating a nonvolatile memory device included in a memory system in accordance with an embodiment of the present disclosure.

### DETAILED DESCRIPTION

Various embodiments of the present disclosure will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

The drawings are not necessarily to scale and, in some instances, proportions may have been exaggerated in order to clearly illustrate features of the embodiments. The terminology used herein is for the purpose of describing particular embodiments only and is not intended to be limiting of the disclosure.

As used herein, the term “and/or” includes at least one of the associated listed items. It will be understood that when an element is referred to as being “connected to”, or “coupled to” another element, it may be directly on, connected to, or coupled to the other element, or one or more intervening elements may be present. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements and do not preclude the presence or addition of one or more other elements.

Hereinafter, various embodiments of the present disclosure will be described below with reference to the accompanying drawings.

According to an embodiment, provided may be a memory system capable of improving write and read performances thereof by evenly arranging open zone blocks for channels, and a controller of the memory system.

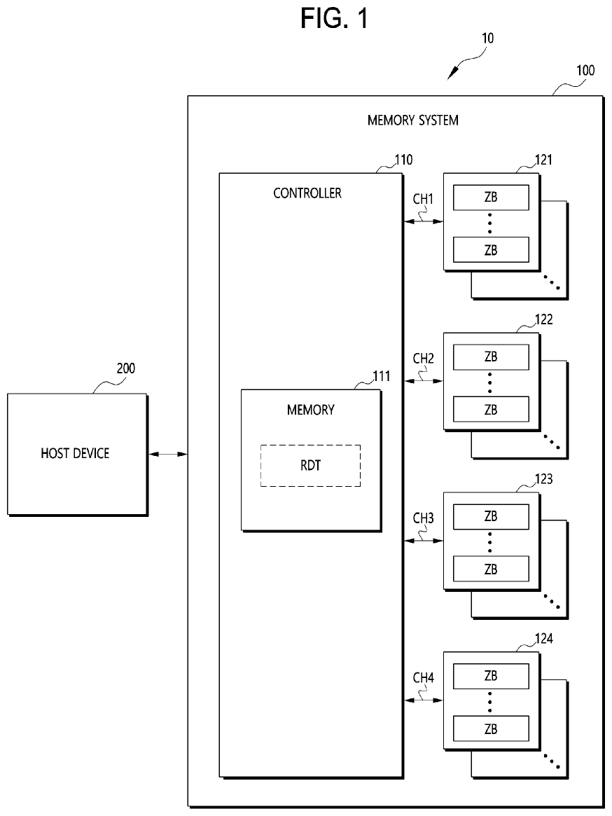

FIG. 1 is a block diagram illustrating a data processing system including a memory system 100 according to an embodiment of the present disclosure.

Referring to FIG. 1, the data processing system 10 may be an electronic system capable of processing data. The data processing system 10 may include a data center, an internet data center, a cloud data center, a personal computer, a laptop computer, a smartphone, a tablet computer, a digital camera, a game console, a navigation, a virtual reality device, a wearable device and so forth.

The data processing system 10 may include a host device 200 and the memory system 100.

The host device 200 may access the memory system 100 by utilizing logical addresses. The host device 200 may assign logical address to data to store the data into the memory system 100.

The host device 200 may configure a plurality of logical regions, that is, a plurality of zones ZONE. Each zone may be configured by consecutive logical addresses. The host device 200 may utilize the consecutive logical addresses configuring each zone in an ascending order from the least logical address to the greatest logical address. That is, the host device 200 may assign, to data, the consecutive logical addresses in an ascending order within each zone. Therefore, a write request provided from the host device 200 to the memory system 100 may be a sequential write request related with the consecutive logical addresses.

The host device 200 may utilize a plurality of open zones simultaneously. An open zone may be a zone that is currently being utilized to store data into the memory system 100. For example, the host device 200 may include a plurality of processors (not illustrated). Each processor may include any of a central processing unit, a graphic processing unit, a microprocessor, an application processor, an accelerated processing unit, an operating system and so forth. An open zone may be assigned to each of the processors to store data into the memory system 100. Specifically, each of the processors may store data into the memory system 100 by assigning, to the data, a logical address within the open zone that is assigned thereto and then by providing the memory system 100 with a write request including the logical address and the data. When each processor utilizes all logical addresses within the open zone assigned thereto, another open zone may be assigned to the processor.

The memory system 100 may be configured to store therein data provided from the host device 200 in response to a write request from the host device 200. The memory system 100 may be configured to provide stored data to the host device 200 in response to a read request from the host device 200. The memory system 100 may include a personal computer memory card international association (PCMCIA) card, a compact flash (CF) card, a smart media card, a memory stick, various multimedia cards (e.g., MMC, eMMC, RS-MMC, and MMC-micro), secure digital (SD) cards (e.g., SD, Mini-SD and Micro-SD), a universal flash storage (UFS) or a solid state drive (SSD).

The memory system 100 may include a controller 110 and a plurality of memory devices 121 to 124.

The controller 110 may control an overall operation of the memory system 100. The controller 110 may control the memory devices 121 to 124 in order to perform a foreground operation in response to an instruction from the host device 200. The foreground operation may include operations of writing data into the memory devices 121 to 124 and reading data from the memory devices 121 to 124 in response to instructions from the host device 200, that is, a write request and a read request.

The controller 110 may control the memory devices 121 to 124 in order to perform a background operation independently of the host device 200. The background operation may include at least one of a wear-leveling operation, a garbage collection operation, an erase operation, a read reclaim operation and a refresh operation for the memory devices 121 to 124. Like the foreground operation, the background operation may include operations of writing data into the memory devices 121 to 124 and reading data from the memory devices 121 to 124.

The controller 110 may manage a plurality of zone blocks ZB included in the memory devices 121 to 124. Each of the zone blocks ZB may be a memory block group comprising one or more memory blocks. Each of the one or more memory blocks configuring each of the zone blocks ZB may be a minimum unit, on which an erase operation is performed at a time. Data stored in each of the zone blocks ZB may be erased all together. The one or more memory blocks configuring each of the zone blocks ZB may be included in a single memory device.

Each of the zone blocks ZB may include memory units respectively corresponding to consecutive physical addresses. The controller 110 may store, according to an order of the physical addresses, data into the memory units within each of the zone blocks ZB. As described below, the controller 110 may store data into an open zone block ZB by mapping an open zone which is utilized by the host device 200, with the open zone block ZB which is included in the memory devices 121 to 124.

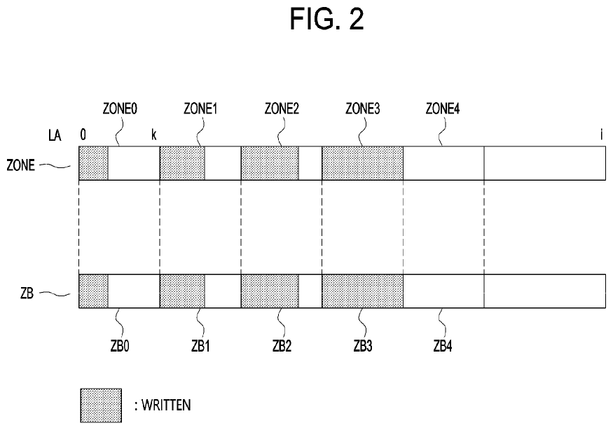

FIG. 2 is a diagram illustrating an operation of mapping zones ZONE with zone blocks ZB according to an embodiment of the present disclosure.

Referring to FIG. 2, the host device 200 may configure a plurality of zones ZONE, for example, zones ZONE0 to ZONE3 by dividing logical addresses LA of values “0” to “i”. Each zone ZONE may be a logical region utilized by the host device 200. Each zone ZONE may correspond to consecutive logical addresses. For example, the zone ZONE0 may correspond to consecutive logical addresses of values “0” to “k”.

A single zone ZONE may be mapped to a single zone block ZB. Each zone block ZB may be a physical region included in the memory devices 121 to 124. For example, the zones ZONE0, ZONE1, ZONE2, ZONE3 and ZONE4 may be mapped respectively to zone blocks ZB0, ZB1, ZB2, ZB3 and ZB4. A size of each zone ZONE may correspond to a size of a corresponding zone block ZB. That is, a size of data corresponding to logical addresses configuring each zone ZONE may be the same as a storage capacity of the corresponding zone block ZB.

When the host device 200 starts utilizing a new open zone ZONE4, the controller 110 may map the new open zone ZONE4 to an empty zone block ZB4, that is, a free zone block. For example, when initially receiving a write request for the new open zone ZONE4 from the host device 200, the controller 110 may map the new open zone ZONE4 to the free zone block ZB4. For example, the controller 110 may receive information of the new open zone ZONE4 from the host device 200 to map the new open zone ZONE4 to the free zone block ZB4. The free zone block ZB4 mapped to the new open zone ZONE4 may become a new open zone block. An open zone block may be a zone block mapped to an open zone.

When receiving a write request for an open zone ZONE from the host device 200, the controller 110 may store data into an open zone block ZB mapped to the open zone ZONE. For example, when the write request is for one or more of the logical addresses of the values “0” to “k”, that is, when the write request is for the open zone ZONE0, the controller 110 may store data in the open zone block ZB0 mapped to the open zone ZONE0.

Each of the zone blocks ZB0, ZB1 and ZB2 may be an open zone block, into which data is being stored. That is, each of the zone blocks ZB0, ZB1 and ZB2 may be an open zone block that is being utilized for storing data therein. The zone block ZB3 may be a full zone block that is full of data stored therein. When an open zone block becomes full of data stored therein, the open zone block may become a full zone block.

Referring back to FIG. 1, the controller 110 may include a memory 111. The memory 111 may operate as a working memory, a buffer memory or a cache memory. The memory 111 as a working memory may be configured to store therein various types of software programs and program data. The memory 111 as a cache memory may be configured to temporarily store cache data. The memory 111 as a buffer memory may be configured to buffer data to be transferred between the host device 200 and the memory devices 121 to 124. The data temporarily stored in the memory 111 may include write data to be stored into the memory devices 121 to 124.

The controller 110 may manage a table RDT of an accumulated amount of read data within the memory 111. The table RDT of the accumulated amount of read data may include information of accumulated amounts of read data respectively corresponding to channels CH1 to CH4. The accumulated amount of read data corresponding to each channel may be an accumulated amount of data read through the channel. Specifically, the accumulated amount of read data corresponding to each channel may be an accumulated amount of data read from one or more memory devices coupled to the channel. The controller 110 may update the table RDT of accumulated amount of read data whenever a read operation is performed on the memory devices 121 to 124.

As described above, the controller 110 may select a free zone block to be mapped to a new open zone of the host device 200. The selected free zone block may become a new open zone block when mapped to the new open zone. In order to maximize the write and read performances for the channels CH1 to CH4, the controller 110 may determine a target channel and may determine a new open zone block within a memory device coupled to the target channel, such that open zone blocks are evenly arranged for the channels CH1 to CH4. In this disclosure, the controller 110 may determine a new open zone block within a memory device by opening a free zone block within the memory device such that the free zone block becomes the new open zone block.

Specifically, according to a determination that there are two or more channels in a predetermined status from among the channels CH1 to CH4, the controller 110 may determine a target channel from among the channels in the predetermined status based on the accumulated amounts of read data respectively corresponding to the channels in the predetermined status and may determine a new open zone block within a memory device coupled to the target channel.

In an embodiment, the controller 110 may determine, as a target channel, a channel corresponding to a minimum accumulated amount of read data from among the channels in the predetermined status.

In an embodiment, according to a determination that there is only one channel in the predetermined status from among the channels CH1 to CH4, the controller 110 may determine the only one channel in the predetermined status to be a target channel.

In an embodiment, according to a determination that there is not any channel in the predetermined status from among the channels CH1 to CH4, the controller 110 may calculate estimated remaining capacities respectively corresponding to the channels CH1 to CH4 and may determine, as a target channel, a channel corresponding to a minimum estimated remaining capacity from among the channels CH1 to CH4. In an embodiment, the controller 110 may calculate an estimated remaining capacity corresponding to a channel based on an available capacity and an amount of write data corresponding to the channel. The available capacity corresponding to a channel may be an available capacity of one or more open zone blocks within one or more memory devices coupled to the channel. The amount of write data corresponding a channel may be an amount of write data that is temporarily stored in the memory 111 and is to be stored in one or more open zone blocks within one or more memory devices coupled to the channel.

In an embodiment, the controller 110 may determine a channel to be in the predetermined status when there is not any open zone block within one or more memory devices coupled to the channel. The predetermined status may be referred to as a not-in-use status. A memory device coupled to a channel in the predetermined status or the not-in-use status may have only a free zone block without any open zone block. The controller 110 may determine a channel to be in an in-use status when there is at least an open zone block within one or more memory devices coupled to the channel.

Under the control of the controller 110, the memory devices 121 to 124 may store therein data provided from the controller 110 and may read therefrom the stored data to provide the controller 110 with the read data. The memory devices 121 to 124 may be accessed and operate, in a parallel way, by the controller 110. The memory devices 121 to 124 may operate according to the interleaving scheme. The memory devices 121 to 124 may be coupled respectively to the channels CH1 to CH4. Each of the channels CH1 to CH4 may be an independent data transmission path. In a parallel way, the channels CH1 to CH4 may transfer signals such as data. One or more memory devices coupled to the same channel may share the data transmission path.

Each of the memory devices 121 to 124 may be a nonvolatile memory apparatus such as a flash memory device (e.g., the NAND Flash or the NOR Flash), the Ferroelectrics Random Access Memory (FeRAM), the Phase-Change Random Access Memory (PCRAM), the Magnetic Random Access Memory (MRAM), the Resistive Random Access Memory (ReRAM) and so forth. Each of the memory devices 121 to 124 may include one or more zone blocks ZB. Each of the memory devices 121 to 124 may include a memory die or a memory chip.

Although FIG. 1 illustrates four channels CH1 to CH4 included in the memory system 100, the number of channels included in the memory system 100 is not be limited thereto.

In an embodiment, the controller 110 may be coupled to the memory devices 121 to 124 through a wired or wireless network, a bus, a hub, a switch and so forth. In an embodiment, the controller 110 and the memory devices 121 to 124 may be located physically apart from each other.

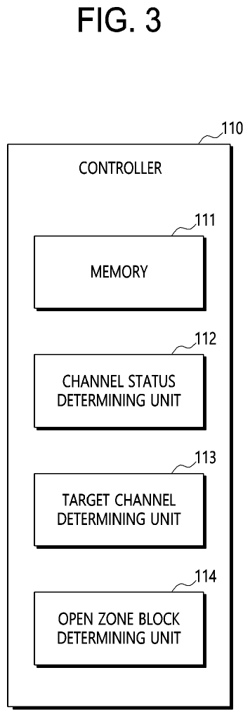

FIG. 3 is a detailed block diagram illustrating the controller 110 according to an embodiment of the present disclosure.

Referring to FIG. 3, the controller 110 may further include a channel status determining unit 112, a target channel determining unit 113 and an open zone block determining unit 114 as well as the memory 111 illustrated in FIG. 1. The controller 110, channel status determining unit 112, target channel determining unit 113 and open zone block determining unit 114 may include all circuits, systems, software, firmware, and devices necessary for their respective operations and functions.

The channel status determining unit 112 may determine statuses respectively corresponding to the channels CH1 to CH4. Specifically, the channel status determining unit 112 may determine whether each of the channels CH1 to CH4 is in the not-in-use status or in the in-use status. The channel status determining unit 112 may determine a channel as in the not-in-use status when there is not any open zone block within one or more memory devices coupled to the channel. The channel status determining unit 112 may determine a channel as in the in-use status when there is at least an open zone block within one or more memory devices coupled to the channel.

According to the determination of the channel status determining unit 112, the target channel determining unit 113 may determine a target channel from among the channels CH1 to CH4 based on channel information. The channel information may include the accumulated amounts of read data respectively corresponding to the channels CH1 to CH4 and/or the estimated remaining capacities respectively corresponding to the channels CH1 to CH4. Specifically, according to the determination of the channel status determining unit 112 that there are two or more channels in the not-in-use status from among the channels CH1 to CH4, the target channel determining unit 113 may determine, as a target channel, a channel corresponding to the minimum accumulated amount of read data from among the channels in the not-in-use status. According to the determination of the channel status determining unit 112 that there is only one channel in the not-in-use status from among the channels CH1 to CH4, the target channel determining unit 113 may determine, as a target channel, the only one channel in the not-in-use status. According to the determination of the channel status determining unit 112 that there is not any channel in the not-in-use status from among the channels CH1 to CH4, the target channel determining unit 113 may determine, as a target channel, a channel corresponding to the minimum estimated remaining capacity from among the channels CH1 to CH4.

When the target channel determining unit 113 determines the target channel from among the channels CH1 to CH4, the open zone block determining unit 114 may determine a new open zone block within a memory device coupled to the target channel.

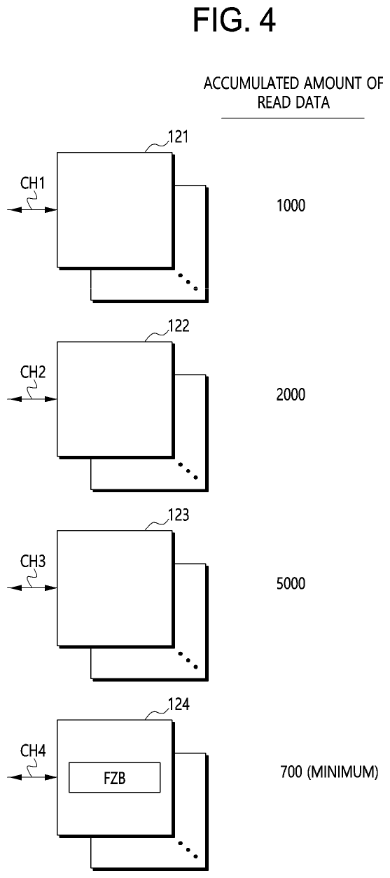

FIGS. 4 to 7 are diagrams illustrating an operation that the controller 110 determines a target channel from among the channels CH1 to CH4 according to an embodiment of the present disclosure.

Referring to FIG. 4, there may be a case that all the channels CH1 to CH4 are in the not-in-use status at a timepoint when a new open zone block has to be determined. That is, there may be a case that there is not any open zone block within the memory devices 121 to 124 coupled to the channels CH1 to CH4 at a timepoint when a new open zone block has to be determined. The target channel determining unit 113 may determine, as a target channel, the channel CH4 corresponding to the minimum accumulated amount of read data (i.e., the accumulated amount ‘700’ of read data illustrated in FIG. 4) from among the channels CH1 to CH4 by referring to the table RDT of accumulated amount of read data. Then, the open zone block determining unit 114 may determine, as a new open zone block, a free zone block FZB included in the memory device 124 coupled to the target channel CH4.

When a new open zone block is determined for the channel CH4 corresponding to the minimum accumulated amount of read data (i.e., the accumulated amount ‘700’ of read data illustrated in FIG. 4), there may be an advantage as follows. A great accumulated amount of read data may mean that read accesses and/or write accesses may be concentrated on a channel corresponding to the great accumulated amount of read data. The concentration of the accesses may reduce an effect of the interleaving on the channels CH1 to CH4. Therefore, the determination of a new open zone block for the channel CH4 corresponding to the minimum accumulated amount of read data (i.e., the accumulated amount ‘700’ of read data illustrated in FIG. 4) may disperse the accesses to the channels CH1 to CH4 thereby maximizing the interleaving effect.

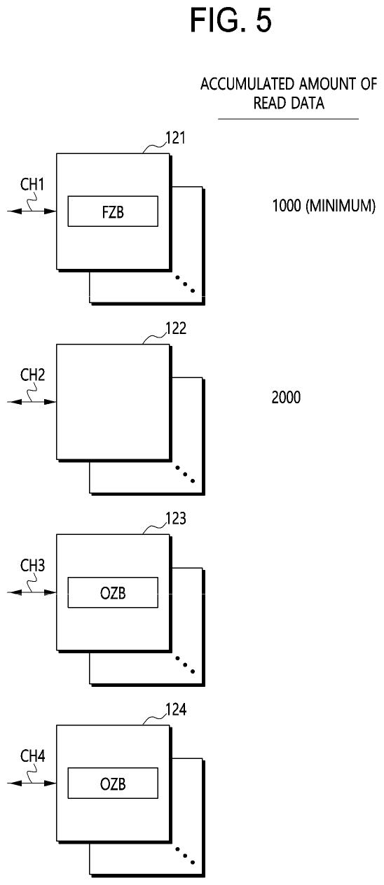

Referring to FIG. 5, there may be a case that the channels CH1 and CH2 are in the not-in-use status and the channels CH3 and CH4 are in the in-use status from among the channels CH1 to CH4 at a timepoint when a new open zone block has to be determined. That is, there may be a case that there is not any open zone block within the memory devices 121 and 122 respectively coupled to the channels CH1 and CH2 and there are open zone blocks OZB within the memory devices 123 and 124 respectively coupled to the channels CH3 and CH4. The controller 110 may determine, as a target channel, the channel CH1 corresponding to the minimum accumulated amount of read data (i.e., the accumulated amount ‘1000’ of read data illustrated in FIG. 5) from among the channels CH1 and CH2 in the not-in-use status. Then, the controller 110 may determine, as a new open zone block, a free zone block FZB included in the memory device 121 coupled to the target channel CH1. That is, the controller 110 may evenly arrange open zone blocks OZB for the channels CH1 to CH4 to disperse the accesses to the channels CH1 to CH4.

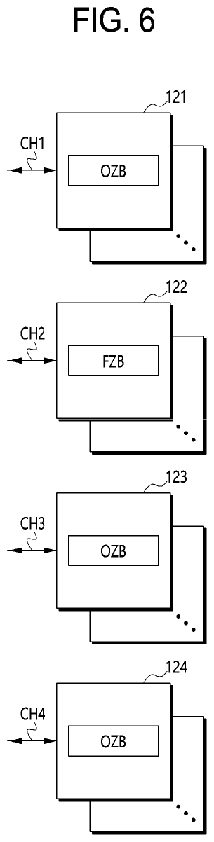

Referring to FIG. 6, there may be a case that only the channel CH2 is in the not-in-use status and the channels CH1, CH3 and CH4 are in the in-use status from among the channels CH1 to CH4 at a timepoint when a new open zone block has to be determined. That is, there may be a case that there is not any open zone block within the memory device 122 coupled to the channel CH2 and there are open zone blocks OZB within the memory devices 121, 123 and 124 respectively coupled to the channels CH1, CH3 and CH4. The controller 110 may determine, as a target channel, the channel CH2 in the not-in-use status. Then, the controller 110 may determine, as a new open zone block, a free zone block FZB included in the memory device 122 coupled to the target channel CH2. That is, the controller 110 may evenly arrange open zone blocks OZB for the channels CH1 to CH4 to disperse the accesses to the channels CH1 to CH4.

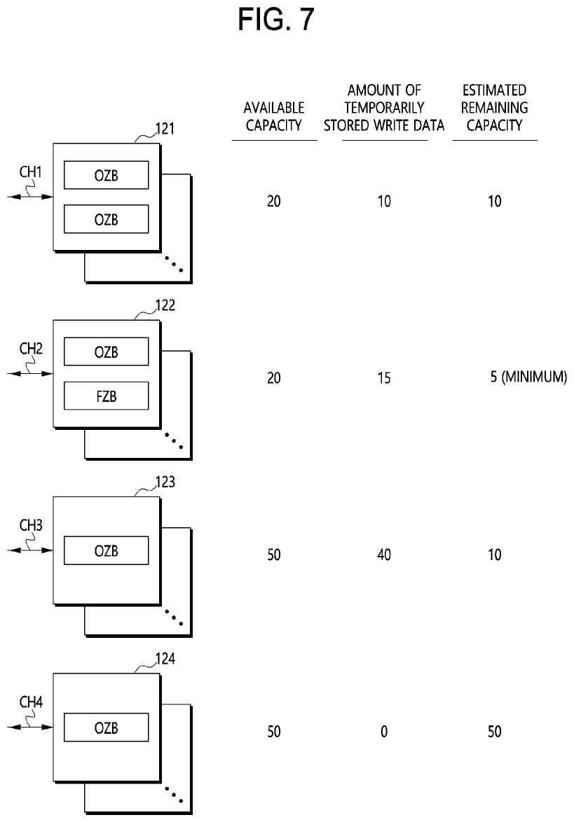

Referring to FIG. 7, there may be a case that all the channels CH1 to CH4 are in the in-use status at a timepoint when a new open zone block has to be determined. That is, there may be a case that there are open zone blocks OZB within all the memory devices 121 to 124 respectively coupled to all the channels CH1 to CH4 at a timepoint when a new open zone block has to be determined. The target channel determining unit 113 may calculate the estimated remaining capacities respectively corresponding to the channels CH1 to CH4 and may determine, as a target channel, the channel CH2 corresponding to the minimum estimated remaining capacity. Then, the open zone block determining unit 114 may determine, as a new open zone block, a free zone block FZB included in the memory device 122 coupled to the target channel CH2.

The estimated remaining capacity corresponding to each channel may be a difference between the available capacity of one or more open zone blocks within one or more memory devices coupled to the channel and the amount of write data, which is temporarily stored in the memory 111 and is to be stored in the one or more open zone blocks. For example, when there are two open zone blocks OZB for the channel CH1, the available capacity (i.e., the value of ‘20’ illustrated in FIG. 7) corresponding to the channel CH1 may be sum of available capacities of the respective two open zone blocks OZB for the channel CH1. The amount (i.e., the value of ‘10’ illustrated in FIG. 7) of write data, which is temporarily stored in the memory 111 for the channel CH1, may be a total amount of write data, which is temporarily stored in the memory 111 and is to be stored in each of the open zone blocks OZB. As a result, the estimated remaining capacity corresponding to the channel CH1 may be calculated as a value of ‘10’, which is the difference between the values ‘20’ and ‘10’.

The minimum estimated remaining capacity corresponding to the channel CH2 may mean that there is a high probability that an open zone block OZB for the channel CH2 becomes a full zone block faster than other open zone blocks OZB. Therefore, even when accesses are concentrated on the channel CH2 due to the two number of open zone blocks OZB for the channel CH2, there may be a high probability that the concentration of the accesses to the channel CH2 becomes relieved in near future. Consequently, the determination of the channel CH2 as a target channel based on the estimated remaining capacity may induce an even assignment of open zone blocks OZB for the channels CH1 to CH4.

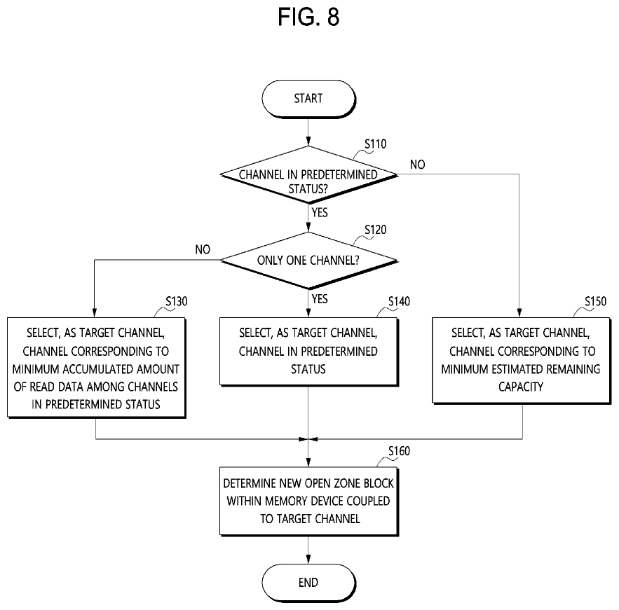

FIG. 8 is a flowchart illustrating an operation of the memory system 100 of FIG. 1 according to an embodiment of the present disclosure. FIG. 8 illustrates an operation that the controller 110 determines a new open zone block.

Referring to FIG. 8, at operation S110, the controller 110 may determine whether there is a channel in the predetermined status. The channel in the predetermined status may be a channel, to which there is not any open zone block within one or more memory devices coupled. That is, the predetermined status may be a not-in-use status and a memory device coupled to a channel in the not-in-use status may have only a free zone block without any open zone block. According to the determination that there is at least a channel in the predetermined status, the process may proceed to operation S120. According to the determination that there is not any channel in the predetermined status, the process may proceed to operation S150.

At operation S120, the controller 110 may determine whether there is only one channel in the predetermined status from among all channels CH1 to CH4. According to the determination that there are two or more channels in the predetermined status, the process may proceed to operation S130. According to the determination that there is only one channel in the predetermined status, the process may proceed to operation S140.

At operation S130, the controller 110 may determine, as a target channel, a channel corresponding to the minimum accumulated amount of read data from among the channels in the predetermined status by referring to the table RDT of accumulated amount of read data.

At operation S140, the controller 110 may determine, as a target channel, the channel in the not-in-use status (i.e., the predetermined status).

At operation S150, the controller 110 may calculate the estimated remaining capacities respectively corresponding to all of the channels CH1 to CH4 and may determine, as a target channel, a channel corresponding to the minimum estimated remaining capacity from among the channels CH1 to CH4.

At operation S160, the controller 110 may determine a new open zone block within a memory device coupled to the target channel by opening a free zone block within the memory device coupled to the target channel such that the free zone block becomes the new open zone block.

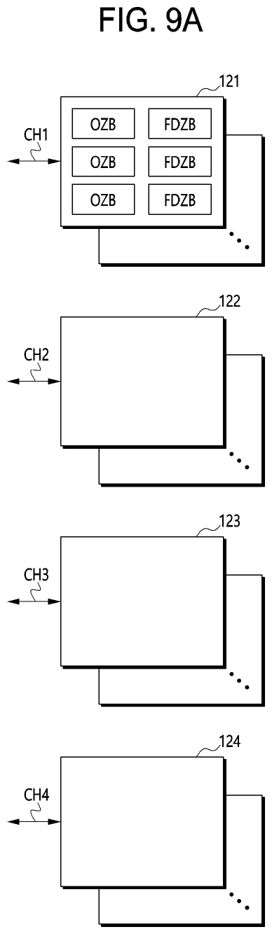

FIGS. 9A and 9B are diagrams illustrating an effect when open zone blocks OZB are evenly arranged for the channels CH1 to CH4 according to an embodiment of the present disclosure.

Referring to FIGS. 9A and 9B, there may be a case that open zone blocks OZB are concentrated on the channel CH1. In this case, a write request from the host device 200 may be processed with the open zone blocks OZB and thus write accesses may be concentrated on the channel CH1. Also, the open zone blocks OZB will eventually become full zone blocks FDZB and thus the concentration of the open zone blocks OZB may lead to the concentration of read accesses to the channel CH1. Accordingly, the performance of the interleaving of the memory devices 121 to 124 will not be maximized.

Referring to FIGS. 9A and 9B, the controller 110 may evenly assign the open zone blocks OZB for the channels CH1 to CH4 according to an embodiment. In this case, the read accesses and/or the write accesses may be evenly made to the channels CH1 to CH4. Accordingly, the performance of the interleaving of the memory devices 121 to 124 may be maximized and thus the performance of the memory system 100 may be improved.

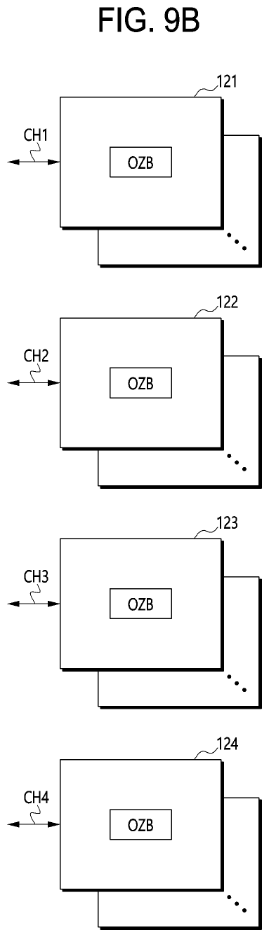

FIG. 10 is a diagram illustrating a data processing system 1000 including a solid state drive (SSD) 1200 in accordance with an embodiment of the present disclosure. Referring to FIG. 10, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may be configured in the same manner as the controller 110 shown in FIG. 1. The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface the host device 1100 and the SSD 1200 according to the protocol of the host device 1100. For example, the host interface unit 1211 may communicate with the host device 1100 through any of communication standards or interfaces such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnect (PCI), PCI express (PCI-e or PCIe) and universal flash storage (UFS).

The control unit 1212 may analyze and process the signal SGL received from the host device 1100. The control unit 1212 may control operations of internal function blocks according to a firmware or a software for driving the SSD 1200. The random access memory 1213 may be used as a working memory for driving such a firmware or software.

The control unit 1212 may include the write unit 110 and the map manager 120 shown in FIG. 1. The random access memory 1213 may include the memory 130 shown in FIG. 1.

The ECC unit 1214 may generate the parity data of data to be transmitted to at least one of the nonvolatile memory devices 1231 to 123n. The generated parity data may be stored together with the data in the nonvolatile memory devices 1231 to 123n. The ECC unit 1214 may detect an error of the data read from at least one of the nonvolatile memory devices 1231 to 123n, based on the parity data. If a detected error is within a correctable range, the ECC unit 1214 may correct the detected error.

The memory interface unit 1215 may provide control signals such as commands and addresses to at least one of the nonvolatile memory devices 1231 to 123n, according to control of the control unit 1212. Moreover, the memory interface unit 1215 may exchange data with at least one of the nonvolatile memory devices 1231 to 123n, according to control of the control unit 1212. For example, the memory interface unit 1215 may provide the data stored in the buffer memory device 1220, to at least one of the nonvolatile memory devices 1231 to 123n, or provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

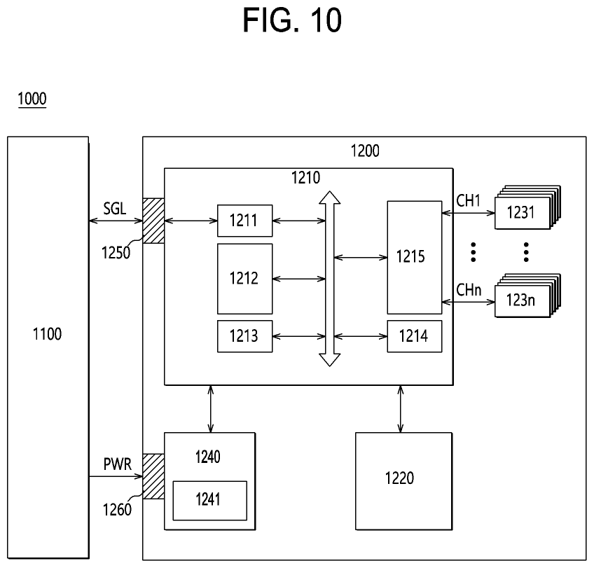

FIG. 11 is a diagram illustrating a data processing system 2000 including a memory system 2200 in accordance with an embodiment of the present disclosure. Referring to FIG. 11, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 10.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200.

The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured into various types depending on an interface scheme between the host device 2100 and the memory system 2200. The connection terminal 2250 may be disposed on any side of the memory system 2200.

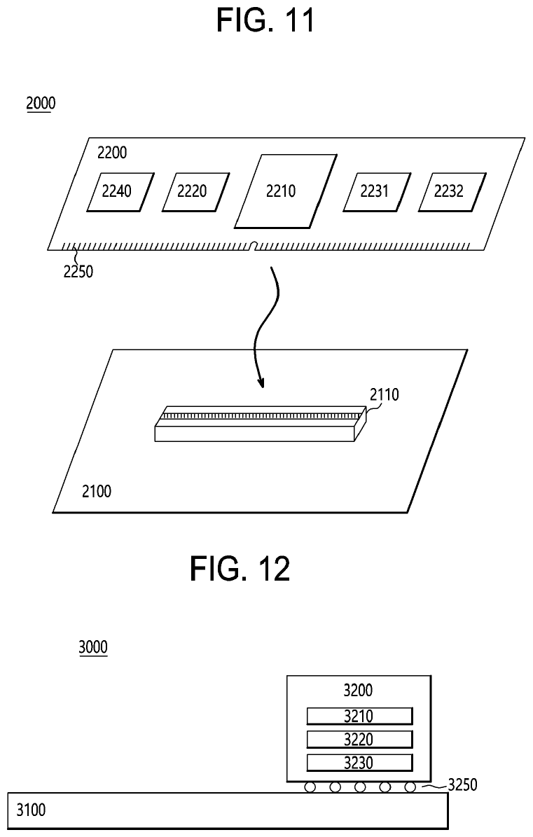

FIG. 12 is a diagram illustrating a data processing system 3000 including a memory system 3200 in accordance with an embodiment of the present disclosure. Referring to FIG. 12, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 10.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

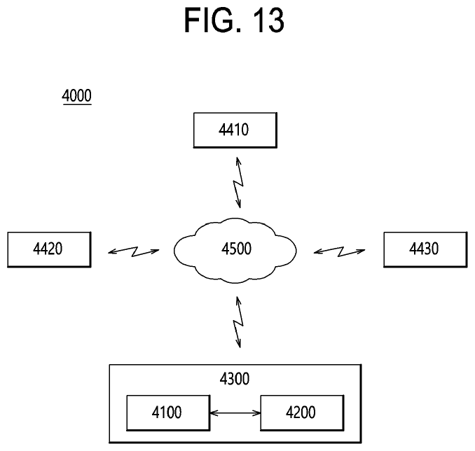

FIG. 13 is a diagram illustrating a network system 4000 including a memory system 4200 in accordance with an embodiment of the present disclosure. Referring to FIG. 13, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 10 shown in FIG. 1, the memory system 1200 shown in FIG. 10, the memory system 2200 shown in FIG. 11 or the memory system 3200 shown in FIG. 12.

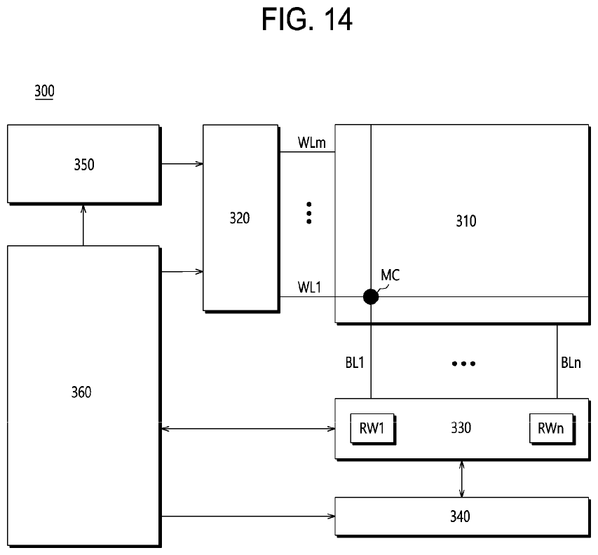

FIG. 14 is a block diagram illustrating a nonvolatile memory device 300 included in a memory system in accordance with an embodiment of the present disclosure. Referring to FIG. 14, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

According to an embodiment, the memory system and the controller of the memory system may improve write and read performances thereof by evenly arranging open zone blocks for channels.

While certain embodiments have been described above, it will be understood to those skilled in the art that the embodiments described are by way of example only. Accordingly, the memory system and controller of memory system should not be limited based on the described embodiments. Rather, the memory system and controller of memory system described herein should only be limited in light of the claims that follow when taken in conjunction with the above description and accompanying drawings. Furthermore, the embodiments may be combined to form additional embodiments.

What is claimed is:

1. A memory system comprising:
a plurality of memory devices each including a plurality of zone blocks, one or more memory devices of the plurality of memory devices being coupled to each of a plurality of channels; and
a controller configured to:
determine, when there are two or more channels in a predetermined status from among the plurality of channels, a target channel from among the plurality of channels in the predetermined status based on accumulated amounts of read data respectively corresponding to the plurality of channels in the predetermined status, and
determine a new open zone block within a memory device coupled to the target channel.

2. The memory system of claim 1, wherein the controller determines, as the target channel, a channel corresponding to a minimum accumulated amount of read data from among the plurality of channels in the predetermined status.

3. The memory system of claim 1, wherein the controller determines, when there is only one channel in the predetermined status from among the plurality of channels, the channel in the predetermined status as the target channel.

4. The memory system of claim 1,
wherein the controller is further configured to calculate, when there is not any channel in the predetermined status from among the plurality of channels, estimated remaining capacities respectively corresponding to the plurality of channels, and
wherein the controller determines, as the target channel, a channel corresponding to a minimum estimated remaining capacity from among the plurality of channels.

5. The memory system of claim 4,
wherein the controller includes a memory configured to temporarily store therein write data to be stored in the plurality of memory devices,
wherein the controller calculates each of the estimated remaining capacities respectively corresponding to the plurality of channels based on an available capacity and an amount of write data corresponding to each of the plurality of channels,
wherein the available capacity is the available capacity of one or more open zone blocks within the one or more memory devices coupled to the channel, and
wherein the amount of write data is an amount of write data, which is temporarily stored in the memory and is to be stored in the one or more open zone blocks within the one or more memory devices coupled to the channel.

6. The memory system of claim 1, wherein the controller is further configured to determine a channel as in the predetermined status when there is not any open zone block within the one or more memory devices coupled to the channel.

7. The memory system of claim 1,
wherein the controller determines the new open zone block by mapping the new open zone block to an open zone, and
wherein the open zone is a logical region utilized by a host device and the new open zone block is a physical region included in the memory device coupled to the target channel.

8. A memory system comprising:
a plurality of memory devices each including a plurality of zone blocks, one or more memory devices of the plurality of memory devices being coupled to each of a plurality of channels; and
a controller configured to:
determine, when all of the plurality of channels are in an in-use status, a target channel from among the plurality of channels based on estimated remaining capacities respectively corresponding to the plurality of channels, and
determine a new open zone block within a memory device coupled to the target channel.

9. The memory system of claim 8, wherein the controller is configured to determine, as the target channel, a channel corresponding to a minimum estimated remaining capacity from among the plurality of channels.

10. The memory system of claim 8,
wherein the controller includes a memory configured to temporarily store therein write data to be stored in the plurality of memory devices,
wherein the controller is further configured to calculate each of the estimated remaining capacities respectively corresponding to the plurality of channels based on an available capacity and an amount of write data corresponding to each of the plurality of channels,
wherein the available capacity is the available capacity of one or more open zone blocks within the one or more memory devices coupled to the channel, and
wherein the amount of write data is an amount of write data, which is temporarily stored in the memory and is to be stored in the one or more open zone blocks within the one or more memory devices coupled to the channel.

11. The memory system of claim 8, wherein the controller is further configured to determine a channel as in the in-use status when there is at least an open zone block within the one or more memory devices coupled to the channel.

12. The memory system of claim 8, wherein the controller is further configured to determine, when there are two or more channels in a not-in-use status from among the plurality of channels, the target channel from among the plurality of channels in the not-in-use status based on accumulated amounts of read data respectively corresponding to the plurality of channels in the not-in-use status.

13. The memory system of claim 12, wherein the controller determines, as the target channel, a channel corresponding to a minimum accumulated amount of read data from among the plurality of channels in the not-in-use status.

14. The memory system of claim 8, wherein the controller is further configured to determine, when there is only one channel in a not-in-use status from among the plurality of channels, the channel in the not-in-use status as the target channel.

15. A controller of a memory system, the controller comprising:
a channel status determining unit configured to determine statuses respectively corresponding to channels, each of which is coupled to one or more memory devices of a plurality of memory devices;
a target channel determining unit configured to determine, according to the determination of the channel status determining unit, a target channel from among the channels based on channel information, which includes accumulated amounts of read data respectively corresponding to the channels and/or estimated remaining capacities respectively corresponding to the channels; and
an open zone block determining unit configured to determine a new open zone block within a memory device coupled to the target channel.

16. The controller of claim 15, wherein the channel status determining unit determines the statuses respectively corresponding to the channels according to whether there is an open zone block within the one or more memory devices coupled to each of the channels.

17. The controller of claim 15, wherein the target channel determining unit determines, when the channel status determining unit determines two or more channels to be in a predetermined status from among the channels, a channel corresponding to a minimum accumulated amount of read data from among the channels in the predetermined status, as the target channel.

18. The controller of claim 15, wherein the target channel determining unit determines, when the channel status determining unit determines any channel not to be in a predetermined status from among the channels, a channel corresponding to a minimum estimated remaining capacity from among the channels, as the target channel.

19. The controller of claim 15,
further comprising a memory configured to temporarily store therein write data to be stored in the plurality of memory devices,
wherein the target channel determining unit is configured to calculate the estimated remaining capacities respectively corresponding to the channels based on an available capacity and an amount of write data corresponding to each of the channels,
wherein the available capacity is the available capacity of one or more open zone blocks within the one or more memory devices coupled to the channel, and
wherein the amount of write data is an amount of write data, which is temporarily stored in the memory and is to be stored in the one or more open zone blocks within the one or more memory devices coupled to the channel.
